(19) United States
(12) Patent Application Publication
(10) Pub. No.: US 2018/0343511 A1
(43) Pub. Date: Nov. 29, 2018

(54) Beverage Containing Radio Assembly

(71) Applicant: Rex Cooper, Swayzee, IN (US)

(72) Inventor: Rex Cooper, Swayzee, IN (US)

(21) Appl. No.: 15/602,258

(22) Filed: May 23, 2017

(51) Int. Cl. H04R 1/02; H04B 1/08; H04R 3/00; B65D 51/24; B65D 43/02; B65D 81/38

(52) U.S. Cl. CPC H04R 1/028; H04B 1/086; H04R 3/00; B65D 51/248; B65D 2543/00537; B65D 81/3865; B65D 51/245; B65D 51/242; B65D 43/0231

(57) ABSTRACT

A beverage containing radio assembly combining a radio with a beverage container includes a container that selectively contains a beverage. The container is comprised of a thermally insulating material to inhibit heat exchange between the beverage and ambient air. A lid is removably coupled to the container and the lid retains the beverage within the container. A radio unit is coupled to the lid and the radio unit is configured to be in electrical communication with an extrinsic communication network. Thus, the radio unit emits audio received from a selected radio station.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to radio devices and more particularly pertains to a new radio device combining a radio with a beverage container.

### (h) BRIEF SUMMARY OF THE INVENTION

An embodiment of the disclosure meets the needs presented above by generally comprising a container that selectively contains a beverage. The container is comprised of a thermally insulating material to inhibit heat exchange between the beverage and ambient air. A lid is removably coupled to the container and the lid retains the beverage within the container. A radio unit is coupled to the lid and the radio unit is configured to be in electrical communication with an extrinsic communication network. Thus, the radio unit emits audio received from a selected radio station.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a beverage containing radio assembly according to an embodiment of the disclosure.

FIG. 2 is a top view of an embodiment of the disclosure.

FIG. 3 is a front view of radio unit of an embodiment of the disclosure.

FIG. 4 is an exploded perspective view of an embodiment of the disclosure.

FIG. 5 is a bottom phantom view of a radio unit of an embodiment of the disclosure.

### (j) DETAILED DESCRIPTION OF THE INVENTION

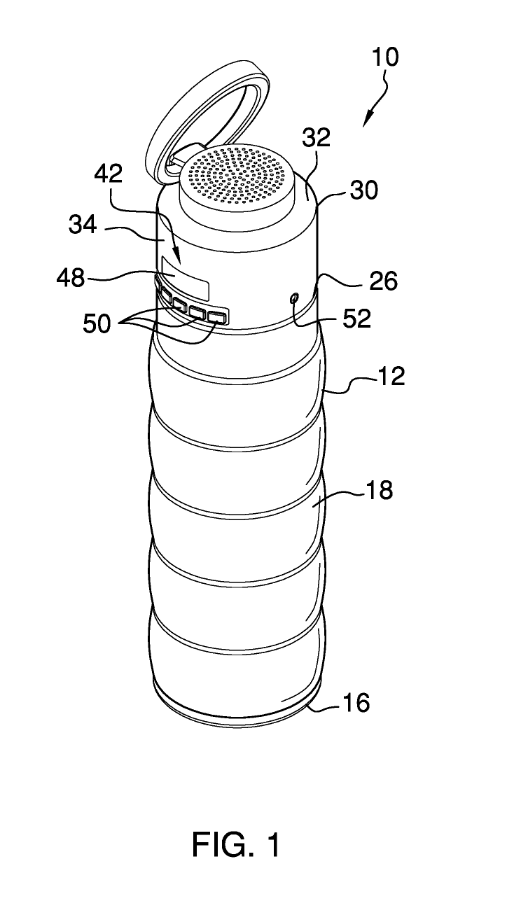

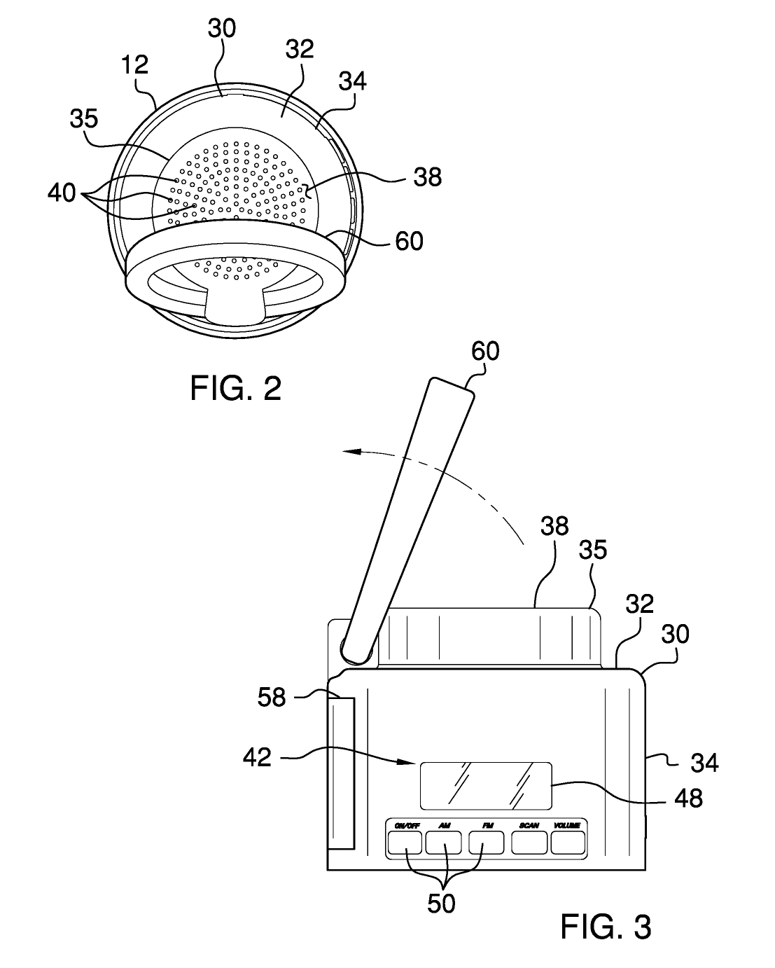

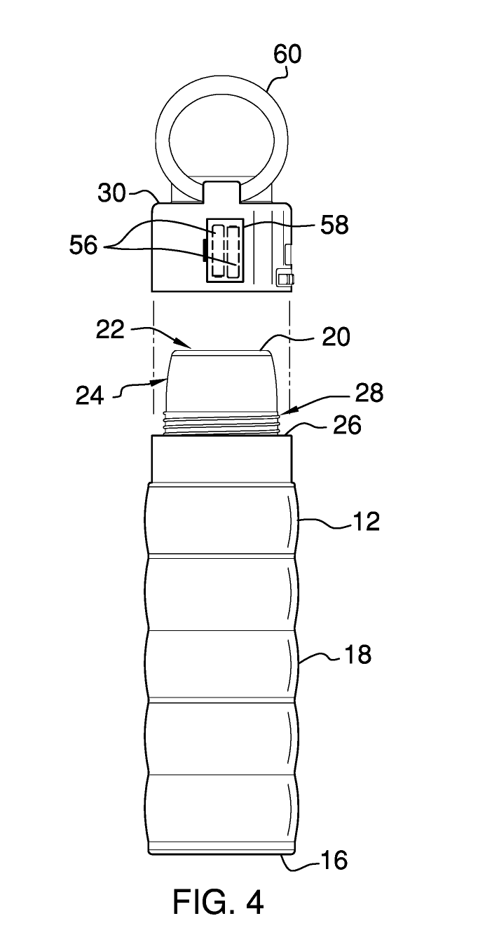

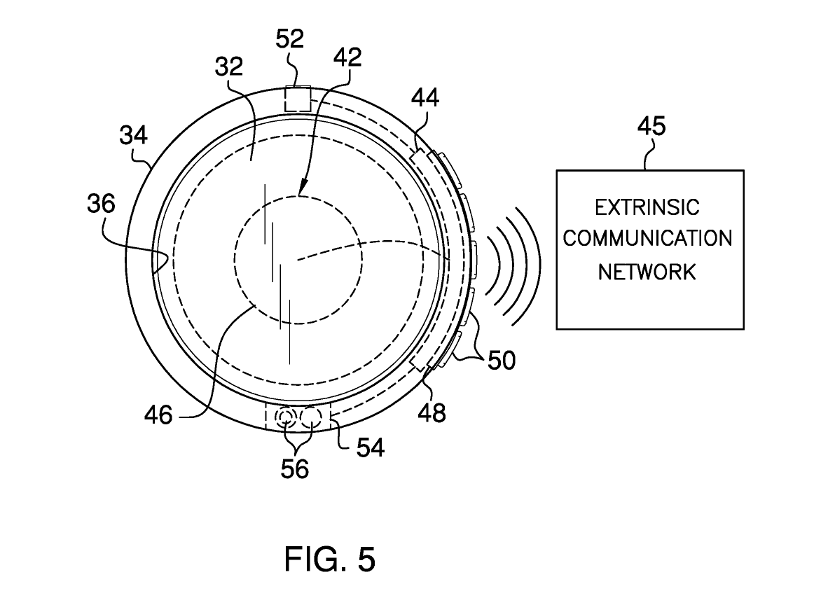

With reference now to the drawings, and in particular to FIGS. 1 through 5 thereof, a new radio device embodying the principles and concepts of an embodiment of the disclosure and generally designated by the reference numeral 10 will be described.

As best illustrated in FIGS. 1 through 5, the beverage containing radio assembly 10 generally comprises a container 12 that selectively contains a beverage. The beverage may be a hot beverage such as coffee and tea. Additionally, the beverage may be a cold beverage such as soda and juice. The container 12 has a bottom wall 16 and an outer wall 18 extending upwardly therefrom and the outer wall 18 is continuous such that the container 12 has a cylindrical shape.

The outer wall 18 has a distal edge 20 with respect to the bottom wall 16 to define an opening 22 into the container 12 to pour and receive the beverage. The container 12 is elongated between the bottom wall 16 and the distal edge 20 and the container 12 is comprised of a thermally insulating material to inhibit heat exchange between the beverage and ambient air. The outer wall 18 has an inset portion 24 extending downwardly from the distal edge 20 and the inset portion 24 has a bounding edge 26. The outer wall 18 has threads 28 extending around the inset portion 24 and the threads 28 are spaced from the distal edge 20.

A lid 30 is removably coupled to the container 12 to retain the beverage within the container 12. The lid 30 has an upper wall 32 and a perimeter wall 34 extending downwardly therefrom and the perimeter wall 34 is continuous such that the lid 30 has a cylindrical shape. The perimeter wall 34 has an inwardly facing surface 36 and the inwardly facing surface 36 threadably engages the threads 28 of the container 12. The lid 30 is retained on the container 12 having the perimeter wall 34 abutting the bounding edge 26 of the inset portion 24. The upper wall 32 has a chamber 35 extending upwardly therefrom and the chamber 35 has a distal surface 38 with respect to the upper wall 32.

The distal surface 38 has a plurality of apertures 40 each extending into an interior of the chamber 35.

A radio unit 42 is coupled to the lid 30 and the radio unit 42 is in electrical communication with an extrinsic communication network 44. In this way the radio emits audio received from a selected radio station. The radio unit 42 comprises a receiver 44 that is coupled to the lid 30. The receiver 44 is in wireless electrical communication with the extrinsic communication network 45 thereby facilitating the receiver 44 to receive a signal from the selected radio station. The receiver 44 may be a radio frequency receiver 44 and the extrinsic communication network 45 may be a broadcast FM and AM signal from radio stations.

A speaker 46 is positioned within the chamber 35 to emit audible sound outwardly through the plurality of apertures 40. The speaker 46 is electrically coupled to the receiver 44 to convert the signal into the audible sound. The speaker 46 may be an electronic speaker 46 or the like. A display 48 is coupled to the perimeter wall 34 such that the display 48 is visible. The display 48 is electrically coupled to the receiver 44 and the display 48 displays indicia corresponding to the selected radio station. The display 48 may be an LCD display or the like.

A plurality of buttons 50 is provided and each of the buttons 50 is coupled to the perimeter wall 34 to be manipulated. Each of the buttons 50 is electrically coupled to the receiver 44 such that the plurality of buttons 50 controls operational parameters of the receiver 44. The plurality of buttons 50 may include a scan button, a power button, an AM button, a FM button and a volume button. A headphone jack 52 is coupled to the perimeter wall 34 and the headphone jack 52 is selectively placed in selective electrical communication with a pair of headphones. The headphone jack 52 is electrically coupled to the receiver 44 to send the signal from the receiver 44 to the headphones. The headphone jack 52 may be a′/4 inch stereo jack or the like.

A power supply 54 is removably coupled to the lid 30 and the power supply 54 is electrically coupled to the receiver 44. The power supply 54 comprises at least one battery 56. A battery cover 58 is removably coupled to the perimeter wall 34 of the container 12. The at least one battery 56 is positioned beneath the battery cover 58. A ring 60 is pivotally coupled the upper wall 32 of the lid 30. The ring 60 is selectively gripped to carry the container 12 when the lid 30 is positioned on the container 12.

In use, the lid 30 is removed from the container 12 to selectively fill the container 12 with the beverage and to pour the beverage from the container 12. The buttons 50 on the lid 30 are selectively manipulated to control the operational parameters of the receiver 44. Thus, the receiver 44 is placed in wireless electrical communication with a selected radio station. In this way the speaker 46 emits the audible sounds from the radio station outwardly through the apertures 40 in the lid 30. The radio unit 42 facilitates the selected radio station to be listened to in conjunction with the container 12. In this way the radio station may be enjoyed on a work site, during 60 outdoor activities and any other occasion.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A beverage containing radio assembly being configured to contain and dispense a beverage and emit audio from a selected radio station, said assembly comprising:
a container being configured to contain a beverage, said container being comprised of a thermally insulating material wherein said container is configured to inhibit heat exchange between the beverage and ambient air;
a lid being removably coupled to said container wherein said lid is configured to retain the beverage within said container, said lid having an upper wall and a perimeter wall extending downwardly therefrom, said perimeter wall being continuous such that said lid has a cylindrical shape, said perimeter wall having an outwardly facing surface; and
a radio unit being coupled to said lid, said radio unit being configured to be in electrical communication with an extrinsic communication network thereby facilitating said radio unit to emit audio received from a selected radio station, said radio unit comprising
a receiver being coupled to said lid, said receiver being configured to be in wireless electrical communication with the extrinsic communication network thereby facilitating said receiver to receive a signal from the selected radio station, and
a plurality of buttons, each of said buttons being coupled to said lid and exposed on said outwardly facing surface of said perimeter wall of said lid adjacent to a bottom edge of said perimeter wall wherein each of said buttons is configured to be manipulated, each of said buttons being electrically coupled to said receiver such that said plurality of buttons controls operational parameters of said receiver.

2. The assembly according to claim 1, wherein said container has a bottom wall and an outer wall extending upwardly therefrom, said outer wall being continuous such that said container has a cylindrical shape, said outer wall having a distal edge with respect to said bottom wall to define an opening into said container wherein said opening is configured to pour and receive the beverage, said container being elongated between said bottom wall and said distal edge.

3. The assembly according to claim 2, wherein said outer wall has an inset portion extending downwardly from said distal edge, said inset portion having a bounding edge, said outer wall having threads extending around said inset portion, said threads being spaced from said distal edge.

4. The assembly according to claim 1, wherein:
said container has threads and an inset portion having a bounding edge; and
said perimeter wall has an inwardly facing surface, said inwardly facing surface threadably engaging said threads of said container to retain said lid on said container having said perimeter wall abutting said bounding edge of said inset portion.

5. The assembly according to claim 4, wherein said upper wall has a chamber extending upwardly therefrom, said chamber having a distal surface with respect to said upper wall, said distal surface having a plurality of apertures each extending into an interior of said chamber.

6. (canceled)

7. The assembly according to claim 1, further comprising:
a chamber being positioned on said lid, said chamber having a plurality of apertures; and
a speaker being positioned within said chamber wherein said speaker is configured to emit audible sound outwardly through said plurality of apertures, said speaker being electrically coupled to said receiver wherein said speaker is configured to convert the signal into the audible sound.

8. The assembly according to claim 1, further comprising a display being coupled to said lid wherein said display is configured to be visible, said display being electrically coupled to said receiver, said display displaying indicia corresponding to the selected radio station.

9. (canceled)

10. The assembly according to claim 1, further comprising a headphone jack being coupled to said lid wherein said headphone jack is configured to be placed in selective electrical communication with a pair of headphones, said headphone jack being electrically coupled to said receiver wherein said headphone jack is configured to send the signal from said receiver to the headphones.

11. The assembly according to claim 1, further comprising a power supply being removably coupled to said lid, said power supply being electrically coupled to said receiver, said power supply comprising at least one battery.

12. A beverage containing radio assembly being configured to contain and dispense a beverage and emit audio from a selected radio station, said assembly comprising:
a container being configured to contain a beverage, said container having a bottom wall and an outer wall extending upwardly therefrom, said outer wall being continuous such that said container has a cylindrical shape, said outer wall having a distal edge with respect to said bottom wall to define an opening into said container wherein said opening is configured to pour and receive the beverage, said container being elongated between said bottom wall and said distal edge, said container being comprised of a thermally insulating material wherein said container is configured to inhibit heat exchange between the beverage and ambient air, said outer wall having an inset portion extending downwardly from said distal edge, said inset portion having a bounding edge, said outer wall having threads extending around said inset portion, said threads being spaced from said distal edge;
a lid being removably coupled to said container wherein said lid is configured to retain the beverage within said container, said lid having an upper wall and a perimeter wall extending downwardly therefrom, said perimeter wall being continuous such that said lid has a cylindrical shape, said perimeter wall having an inwardly facing surface and an outwardly facing surface, said inwardly facing surface threadably engaging said threads of said container to retain said lid on said container having said perimeter wall abutting said bounding edge of said inset portion, said upper wall having a chamber extending upwardly therefrom, said chamber having a distal surface with respect to said upper wall, said distal surface having a plurality of apertures each extending into an interior of said chamber; and
a radio unit being coupled to said lid, said radio unit being configured to be in electrical communication with an extrinsic communication network thereby facilitating said radio unit to emit audio received from a selected radio station, said radio unit comprising:
a receiver being coupled to said lid, said receiver being configured to be in wireless electrical communication with the extrinsic communication network thereby facilitating said receiver to receive a signal from the selected radio station,
a speaker being positioned within said chamber wherein said speaker is configured to emit audible sound outwardly through said plurality of apertures, said speaker being electrically coupled to said receiver wherein said speaker is configured to convert the signal into the audible sound,
a display being coupled to said perimeter wall wherein said display is configured to be visible, said display being electrically coupled to said receiver, said display displaying indicia corresponding to the selected radio station,
a plurality of buttons, each of said buttons being coupled to and exposed on said outwardly facing surface of said perimeter wall of said lid adjacent to a bottom edge of said perimeter wall wherein each of said buttons is configured to be manipulated, each of said buttons being electrically coupled to said receiver such that said plurality of buttons controls operational parameters of said receiver,
a headphone jack being coupled to said perimeter wall wherein said headphone jack is configured to be placed in selective electrical communication with a pair of headphones, said headphone jack being electrically coupled to said receiver wherein said headphone jack is configured to send the signal from said receiver to the headphones, and
a power supply being removably coupled to said lid, said power supply being electrically coupled to said receiver, said power supply comprising at least one battery.
